(19) United States
(12) Patent Application Publication
(10) Pub. No.: US 2021/0224855 A1
(43) Pub. Date: Jul. 22, 2021

(54) FOCO Device

(71) Applicant: Joubert Joseph, Groveland, FL (US)

(72) Inventor: Joubert Joseph, Groveland, FL (US)

(21) Appl. No.: 17/152,313

(22) Filed: Mar. 5, 2021

Related U.S. Application Data
(60) Provisional application No. 62/964,006, filed on Jan. 21, 2020.

(51) Int. Cl. G06Q 30/02; G07C 5/02; G06F 8/65; B60R 13/00; H04N 5/247; G06F 3/14; G06T 7/70

(52) U.S. Cl. CPC G06Q 30/0266; G07C 5/02; G06Q 30/0242; G06Q 30/0274; G06N 5/04; B60R 13/00; H04N 5/247; G06F 3/1423; G06T 7/70; G06F 8/65

(57) ABSTRACT

A display device for displaying advertisements in a moving vehicle, the display device is equipped with data storage medium for storing program code, cameras fixed on to front and rear sides of the display device for capturing images and display screens for displaying the advertisements, wherein, the plurality of advertisements displayed are based on the plurality of images captured. The display device processes the captured images to determine location information.

### 1. FIELD OF THE INVENTION

The present invention generally relates to advertisement display device, more particularly invention relates to a display device for displaying digital advertisements in a moving vehicle.

### 2. BACKGROUND OF THE INVENTION

It is common for advertisers to place advertisements and other messages (“content”) in advertising spaces at fixed locations, such as billboards or on buildings. The content is periodically changed at the discretion of the advertiser, or at the discretion of the person leasing the advertising space. The effectiveness of the content depends largely on the number of people who see it, as well as the relevance of the content to the people who see it.

To allow more people to see an advertisement, advertisements are also commonly placed on moving vehicles such as buses, taxicabs, and the like but again the problem arises that the advertisements are only displayable on the moving vehicles. Therefore, advertisers have enormous disadvantages of existing technologies due to non-tracking, non-monitoring and non-locating ads-based capabilities of streets media advertising of the digital out of home advertising industry.

Thus, there is a need to develop a display device for displaying digital advertisements in a moving vehicle to overcome the above problems.

### 3. BRIEF SUMMARY OF THE INVENTION

The present invention is a system and method for displaying advertisements on a display device (FOCO Device) attached to a moving vehicle. The display device is equipped with cameras to capture images or photos of a location or vicinity and the display device is configured to process the captured images or photos to determine the location or vicinity. The advertisements are generated based on the determined location or vicinity and displayed on the display screens equipped to the display device.

In one embodiment, the moving vehicle can be a car, a bus, a taxi, a train or an autonomous vehicle but not restricted to above mention.

In one embodiment of the present invention, the advertisements can be of a graphical image, a video or a plurality of images.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### 4. BRIEF DESCRIPTION OF THE DRAWINGS

FIG. 1 illustrates an isometric view of the FOCO device to display different formats, themes and sizes of advertisements, in accordance with an embodiment of the present invention.

FIG. 2 illustrates an isometric view of the FOCO device to display different formats, themes and sizes of advertisements, in accordance with an embodiment of the present invention.

FIG. 3 illustrates a front view of the FOCO device.

FIG. 4 illustrates a rear view of the FOCO device.

FIG. 5 illustrates a right side view of the FOCO device.

FIG. 6 illustrates a left side view of the FOCO device.

FIG. 7 illustrates a bottom view of the FOCO device.

FIG. 8 illustrates a top view of the FOCO device.

### 5. DETAILED DESCRIPTION OF THE INVENTION

The invention relates to improved or smart approach for displaying advertisements on moving vehicles using a display device (FOCO). The FOCO device is equipped with various sensors and software developed based on various technologies like Artificial Intelligence, Machine Learning, Block chain and Automation.

In the following description, numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

In one embodiment, the display device is pivotally mounted on to a moving vehicle and is rotatable in 360 degrees. The display device facilitates clockwise rotation in four directional points when the moving vehicle is in a standing position.

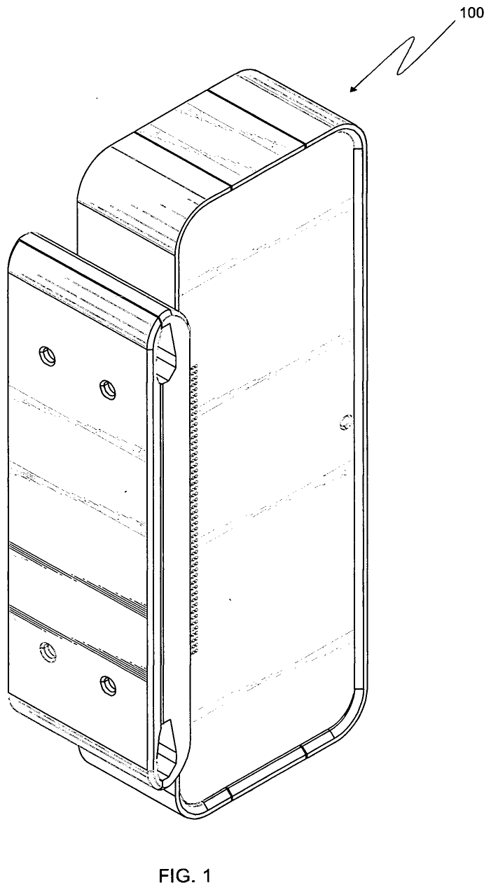

FIG. 1 illustrates an isometric view of the FOCO device 100 intended to display different formats, themes and sizes of advertisements respectively, in accordance with an embodiment of the present invention.

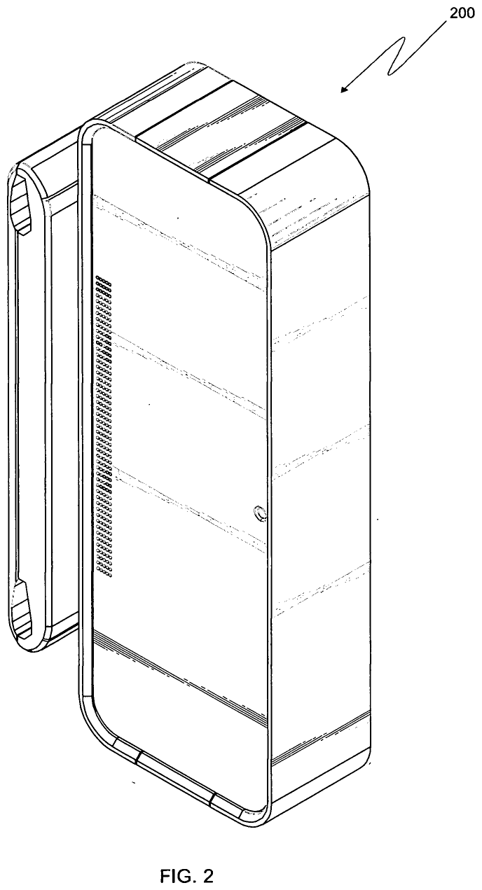

FIG. 2 illustrates an isometric view of the FOCO device 200, the device 200 is pivotally attached to a Vehicle.

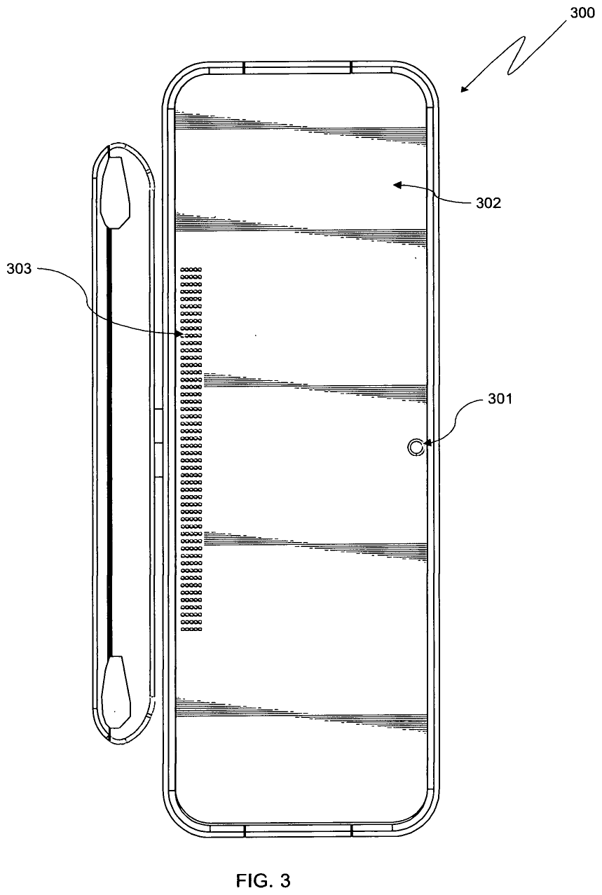

FIG. 3 a front view of a device 300 to display different formats, themes and sizes of advertisements respectively, in accordance with an embodiment of the present invention. The device 300 is a FOCO device which comprises a front display screen 302, a front camera 301 and a front audio output component 303.

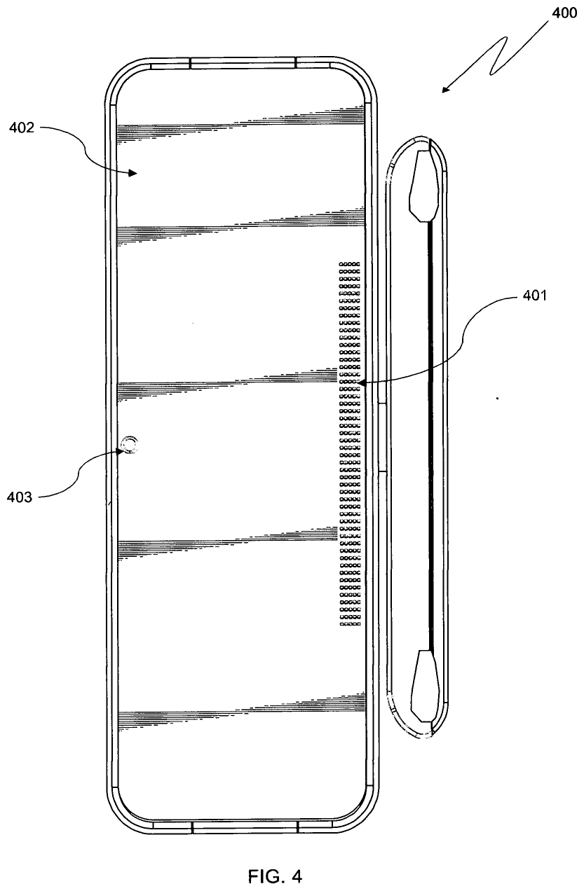

FIG. 4 illustrates a rear view of a display device 400 and the display device 400 comprises a rear display screen 402, a rear camera 403, and a rear audio output component 401. Wherein, the display device 400 facilitates clockwise rotation in four directional points only when the vehicle is in standing position. The device displays ads-based location in real time, on route and on demand with navigation systems, internet connectivity and cloud infrastructure.

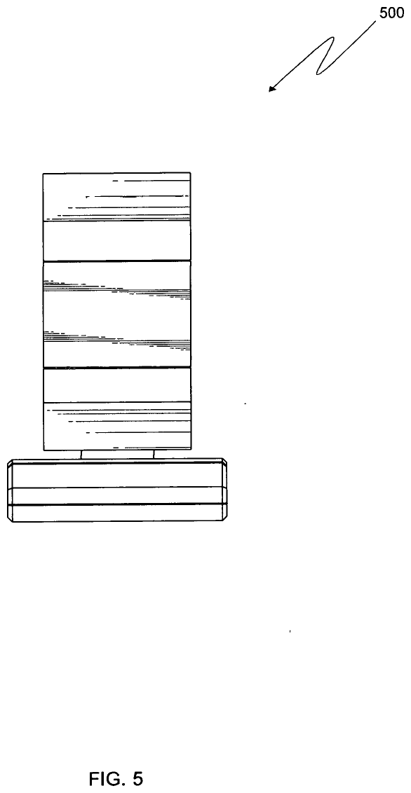

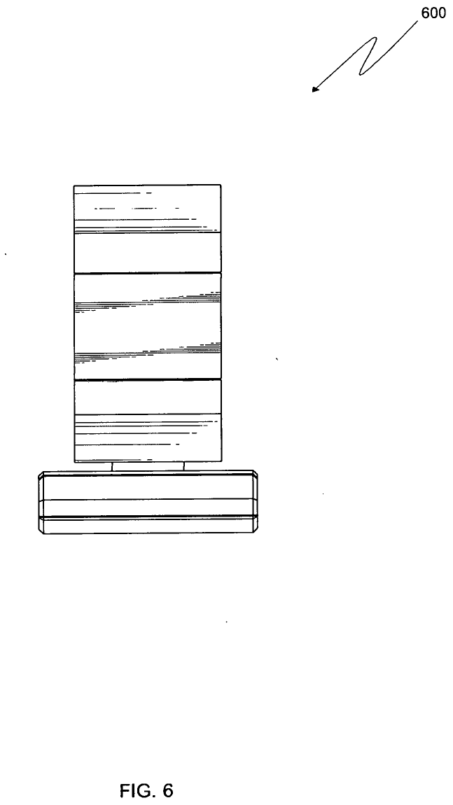

FIGS. 5 and 6 illustrates a right side and a left side views of the FOCO Device.

In one embodiment of the present invention, a media selling unit is there which empowers the driving community to make additional income through ride-ailing advertising. The FOCO device generates records and reports of mileages and ads performed and played. The device also can transact, infotain, and share benefits and rewards to Foco users and affiliates.

In another embodiment of the present invention, the device provides a new and digital platform for advertising ads outside of home especially in a vehicle. This city media unit can assure city government officials of public safety, guarantee business owners of ads performance and brand awareness and expose social entrepreneurs of more visibility and view ability.

In other embodiment, of the present invention, the device is smart and artificially intelligent and can leverage the patented technologies to display, monitor and analyze of all ads in our platform.

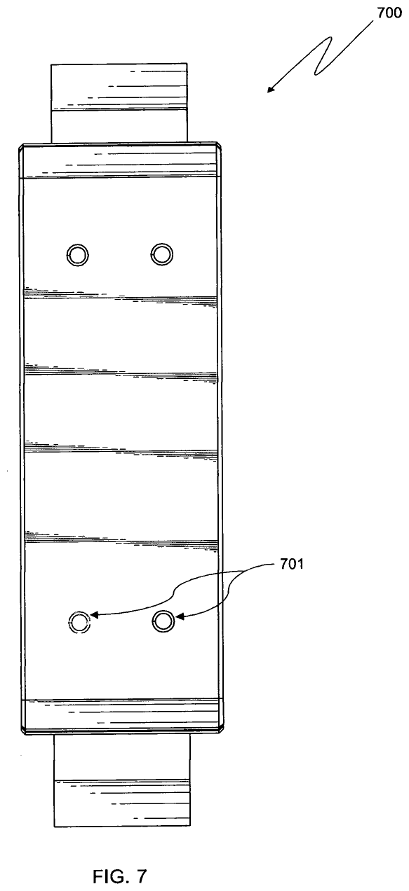

FIG. 7 illustrates a bottom view of the FOCO device 700. The FOCO device 700 includes multiple mounting rack fixing parts 701 intended for firmly attaching to a vehicle. In one embodiment of the present invention, outer shell color of the FOCO device 700 is customized as per user's requirement. A protection layer is there on the display screen 402 and 302, surface and mounting rack to lock it and to keep it from being damaged and unsafe. Choosing panels based on terms with suppliers. Support software updating, new functions can be customized according to customer's needs.

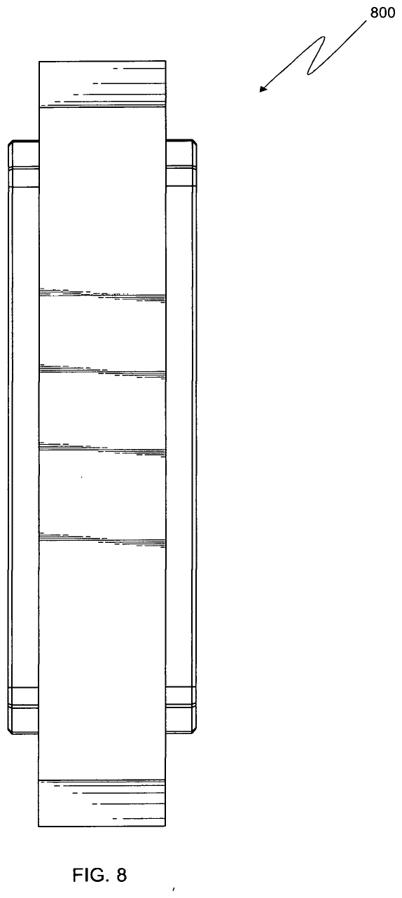

FIG. 8 illustrates a Top view of the FOCO device 800. In other embodiment, the FOCO Device 800 can be a display device or an electronic device equipped with display screens. The FOCO Device is configured to display different formats, themes and sizes of advertisements.

In other embodiment, the display device displays the advertisements based on a location, a route, a demand on navigation systems, internet connectivity or a cloud infrastructure.

In other embodiment, the FOCO display device is configured to generate records of the advertisements displayed, mileage readings of the moving vehicle and reports on performance of the advertisements displayed.

In another embodiment, the FOCO Device can transact, infotain, share benefits and rewards to device users or vehicle owners and affiliates based on the generated records and reports on the advertisements displayed.

In one embodiment, the FOCO Device monitors and analyzes the advertisements displayed on the display screens of the FOCO Device. The display screens are provided with a protection layer and a mounting rack to lock the display screens to the FOCO Device

In another embodiment, the display device is installed with a support software and the support software is updated with new functions based on requirements of the device users or owners.

In other embodiment, the device users can be one of a digital billboard business user, an individual user, a billboards advertising firm, a Rooftop taxi advertising user, a Digital media display, a Delivery entity, a passenger transportation entity, a goods courier firm, a mail courier firm or a commercial vehicles renting firm.

In one embodiment, the advertisements displayed on the FOCO Device can be location based ads, tagged ads, user specific ads or sponsored ads etc. and the FOCO Device may also include a support software installed that utilizes technologies like artificial intelligence or smart processing to monitor, analyze and display the advertisements.

In another embodiment, the FOCO Device may also be equipped with GPS sensor, location detection sensor, human detection sensor or wireless communication sensor etc. The FOCO Device can also utilize various wireless technologies like Bluetooth, WLAN, 3G, 4G, 5G mobile networks or satellite connections for communicating with server or other devices.

As mentioned, there remains the foregoing description of the specific embodiments that will fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those with skills in the art will recognize that the embodiments herein can be practiced with modification within the spirit and scope of the appended claims.

Embodiments may also include computer program products for use in the systems of the present invention, the computer program product having a physical computer-readable having a computer readable program code stored thereon, the computer readable program code comprising computer executable instructions, that when executed by a processor, cause the system to perform the methods of the present invention.

The present invention may be embodied in other specific forms without departing from its spirit or essential characteristics. The described embodiments are to be considered in all respects only as illustrative and not restrictive. The scope of the invention is, therefore, indicated by appended claims rather than by the foregoing description. All changes which come within the meaning and range of equivalency of the claims are to be embraced within their scope.

1. A display device for displaying a plurality of advertisements in a moving vehicle, the display device comprises of:
a) a physically tangible storage medium storing computer readable program code;
b) at least two cameras fixed on to front and rear sides of the display device, wherein, the at least two cameras configured to capture a plurality of images; and
c) at least two display screens for displaying the plurality of advertisements, wherein, the plurality of advertisements displayed are based on the plurality of images captured.

2. The display device according to claim 1, wherein the display device is pivotally mounted on to the moving vehicle.

3. The display device according to claim 2, wherein the display device is rotatable in 360 degrees.

4. The display device according to claim 3, wherein the display device facilitates clockwise rotation in four directional points when the moving vehicle is in a standing position.

5. The display device according to claim 1, wherein the display device displays the plurality of advertisements based on one or more of a location, a route, a demand on navigation systems, internet connectivity or a cloud infrastructure.

6. The display device according to claim 1, wherein the display device is configured to generate one or more records of the plurality of advertisements displayed, mileage readings of the moving vehicle and one or more reports on performance of the advertisements displayed.

7. The display device according to claim 6, wherein the display device can transact, infotain, share benefits and rewards to one or more device users and affiliates based on the generated records and reports on the displayed plurality of advertisements.

8. The display device according to claim 1, wherein the display device is configured to monitor and analyze the plurality of advertisements displayed.

9. The display device according to claim 1, wherein the at least two display screens has a protection layer and a mounting rack to lock the screens to the display device.

10. The display device according to claim 7, wherein the display device is installed with a support software, wherein, the support software is updated with one or more new functions based on requirements of the one or more device users.

11. The display device according to claim 10, wherein the one or more device users include one of a digital billboard business user, an individual user, a billboards advertising firm, a Rooftop taxi advertising user, a Digital media display, a Delivery entity, a passenger transportation entity, a goods courier firm, a mail courier firm or a commercial vehicles renting firm.

12. The display device according to claim 1, wherein the plurality of advertisements displayed on the at least two display screens displays includes location based advertisements.

13. The display device according to claim 10, wherein the support software installed in the display device utilizes one or more technologies like artificial intelligence or smart processing to monitor, analyze and display the plurality of advertisements.

14. A method for displaying a plurality of advertisements on a display device in a moving vehicle, the method comprising:
a) capturing a plurality of images by, at least two cameras fixed on to front and rear sides of the display device;
b) determining a location based on the captured plurality of images by an artificial intelligence support software equipped in the display device;
c) generating the plurality of advertisements by the artificial intelligence support software; and
d) displaying the generated plurality of advertisements by at least two display screens attached on the display device.

15. The method of claim 14, wherein the display device is rotatable in 360 degrees and pivotally mounted on to the moving vehicle.

16. The method of claim 14, wherein the display device displays the plurality of advertisements based on one or more of a location, a route, a demand on navigation systems, internet connectivity or a cloud infrastructure.

17. The method of claim 14, wherein the display device is configured to generate one or more records of the plurality of advertisements displayed, mileage readings of the moving vehicle and one or more reports on performance of the advertisements displayed.

18. The method of claim 14, wherein the display device is configured to monitor and analyze the plurality of advertisements displayed.

19. The method of claim 14, wherein the support software is updated with one or more new functions based on requirements of one or more device users.

20. The method of claim 14, wherein the at least two display screens has a protection layer and a mounting rack to lock the screens to the display device.
